(19) United States
(12) Patent Application Publication
(10) Pub. No.: US 2019/0197973 A1
(43) Pub. Date: Jun. 27, 2019

(54) GATE DRIVER AND DRIVING CIRCUIT

(71) Applicant: SHENZHEN CHINA STAR OPTOELECTRONICS TECHNOLOGY CO., LTD., Shenzhen (CN)

(72) Inventor: Shuai CHEN, Shenzhen (CN)

(21) Appl. No.: 16/003,532

(22) Filed: Jun. 8, 2018

Related U.S. Application Data
(63) Continuation of application No. PCT/CN2018/072888, filed on Jan. 16, 2018.

(30) Foreign Application Priority Data
Dec. 26, 2017 (CN) 201711439365.4

(51) Int. Cl. G09G 3/36

(52) U.S. Cl. CPC G09G 3/3677; G09G 2310/06; G09G 2310/08; G09G 2320/0219

(57) ABSTRACT

The present disclosure provides a gate driver and driving circuit, wherein, the gate driver comprises a pull-up control module, a pull-down holding module, a pull-up module, a signal down-transmitting module, a pull-down module and a self-raising module. The pull-up control module, the pull-down holding module, the pull-up module, the signal down-transmitting module, the pull-down module, and the self-raising module are connected at a gate signal point; the pull-down holding module, the self-raising module, the pull-up module and the pull-down module are connected to a horizontal scan line, respectively. The present disclosure pulls down the level of the horizontal scan line by using the pull-up module together with the pull-down module so that the pull-down effect of the gate driver and the stability of the circuit are improved.

### RELATED APPLICATIONS

This application is a continuation application of PCT Patent Application No. PCT/CN2018/072888, filed Jan. 16, 2018, which claims the priority benefit of Chinese Patent Application No. 201711439365.4, filed Dec. 26, 2017, which is herein incorporated by reference in its entirety.

### FIELD OF THE DISCLOSURE

The disclosure relates to an electronic technical field, and more particularly to a gate driver and driving circuit.

### BACKGROUND

Gate Driver on Array (GOA) is an electronic device used for scanning and driving liquid crystal panel. Gate drivers are often used in various displays due to their low cost and high efficiency, for example, Active-matrix organic light emitting diodes (AMOLEDs). Because AMOLED is progressed fast, the gate driver is also the focus of the future development of LCD panels technology.

In more sophisticated circuits, capacitive coupling is a problem that cannot be ignored. Capacitive coupling means that there is capacitance between any two conductive conductors, such as capacitances between power transmission lines, between power transmission lines and ground, between pins of transistor, and between components and components. If the capacitive coupling between the data line in the liquid crystal panel and the horizontal signal scan line in the gate driver is very serious, the gate driver may not be able to pull down the potential on the horizontal scanning line of the liquid crystal panel, so that the gate of the liquid crystal panel cannot be effectively closed, thereby resulting in abnormal frame display.

Due to the capacitive coupling in the circuit is severe, and the gate driver does not provide enough force for pulling, the level of the horizontal scan line of the gate driver cannot be effectively pulled down.

### SUMMARY

The present disclosure provides a gate driver to effectively pull down the level of the horizontal scan line of the gate driver and improve the stability of the circuit.

In a first aspect, the present disclosure provides a gate driver comprising a pull-up control module, a pull-down holding module, a pull-up module, a signal down-transmitting module, a pull-down module and a self-raising module; wherein, the pull-up control module comprises a first terminal; the pull-down holding module comprises a first terminal, a second terminal and a third terminal; the pull-up module comprises a first terminal, a second terminal and a third terminal; the signal down-transmitting module comprises a first terminal and a second terminal; the pull-down module comprises a first terminal, a second terminal, a third terminal, a fourth terminal and a fifth terminal; and the self-raising module comprises a first terminal and a second terminal;

the first terminal of the pull-up control module, the first terminal of the pull-up module, the first terminal of the signal down-transmitting module, the first terminal of the pull-down module, the first terminal of the pull-down holding module and the first terminal of the self-raising module are connected at a gate signal point; the second terminal of the pull-down holding module, the second terminal of the pull-down module, the second terminal of the self-raising module and the second terminal of the pull-up module are connected to a horizontal scan line, respectively; the third terminal of the pull-down holding module and the third terminal of the pull-down module are connected to a low level signal line, respectively; the third terminal of the pull-up module and the second terminal of the signal down-transmitting module are connected to a clock signal line, respectively;

the pull-up control module is configured for pre-charging the gate signal point, and, when the gate signal point is at high level, the pull-up module is controlled to output a signal of the clock signal line to the horizontal scan line; the pull-down module outputs a signal of the low-level signal line to the horizontal scan line when a first control signal received by the fourth terminal of the pull-down module is at high level; the pull-down module outputs the signal of the low level signal line to the gate signal point to control the pull-down holding module to output the signal of the low level signal line to the horizontal scan line when a second control signal received by the fifth terminal of the pull-down module is at high level; the self-raising module is configured for raising and maintaining a level of the gate signal point; the signal down-transmitting module is configured for transmitting the signal of the clock signal line to other electronic component when the gate signal point is at high level.

Referring to the first aspect, in a first implementation of the first aspect, the first control signal is different from the second control signal.

Referring to the first aspect and any implementation of the first aspect described above, in a second implementation of the first aspect, the pull-up control module comprises a first-first transistor; a source electrode of the first-first transistor is connected to the gate signal point; and when a gate electrode of the first-first transistor is at high level, the first-first transistor is controlled to transmit a signal received from a drain electrode of the first-first transistor to the source electrode of the first-first transistor.

Referring to the first aspect and any implementation of the first aspect described above, in a third implementation of the first aspect, the pull-up module comprises a second-first transistor; a gate electrode of the second-first transistor is connected to the gate signal point; a drain electrode of the second-first transistor is connected to the second terminal of the signal down-transmitting module; and a source electrode of the second-first transistor is connected to the horizontal scan line; when the gate electrode of the second-first transistor is at high level, the drain electrode of the second-first transistor is controlled to transmit the signal of the clock signal line to the source electrode of the second-first transistor.

Referring to the first aspect and any implementation of the first aspect described above, in a fourth implementation of the first aspect, the signal down-transmitting module comprises a third-first transistor; a gate electrode of the third-first transistor is connected to the gate signal point; and a drain electrode of the third-first transistor is connected to the third terminal of the pull-up module; when the gate electrode of the third-first transistor is at high level, the drain electrode of the third-first transistor is controlled to transmit the signal of the clock signal line to a source electrode of the third-first transistor.

Referring to the first aspect and any implementation of the first aspect described above, in a fifth implementation of the first aspect, the pull-down module comprises a fourth-first transistor and a fourth-second transistor; a drain electrode of the fourth-first transistor is connected to the horizontal scan line, and a drain electrode of the fourth-second transistor is connected to the gate signal point; a source electrode of the fourth-first transistor and a source electrode of the fourth-second transistor are connected to the pull-down holding module; a gate electrode of the fourth-first transistor and a gate electrode of the fourth-second transistor are configured for receiving the first control signal and the second control signal, respectively; when the gate electrode of the fourth-first transistor is at high level, the source electrode of the fourth-first transistor is controlled to transmit the signal of the low level signal line to the drain electrode of the fourth-first transistor; when the gate electrode of the fourth-second transistor is at high level, the source electrode of the fourth-second transistor is controlled to transmit the signal of the low level signal line to the drain electrode of the fourth-second transistor.

Referring to the first aspect and any implementation of the first aspect described above, in a sixth implementation of the first aspect, the pull-down holding module comprises an inverter, a fifth-first transistor and a fifth-second transistor; an input terminal of the inverter is connected to the gate signal point, and an output terminal of the inverter is connected to a gate electrode of the fifth-first transistor and a gate electrode of the fifth-second transistor; a drain electrode of the fifth-first transistor is connected to the horizontal scan line, and a source electrode of the fifth-first transistor is connected to the third terminal of the pull-down module; a drain electrode of the fifth-second transistor is connected to the gate signal point, and a source electrode of the fifth-second transistor is connected to the third terminal of the pull-down module; when the input terminal of the inverter is at low level, the output terminal of the inverter outputs high level to the gate electrode of the fifth-first transistor to control the fifth-first transistor to transmit the signal of the low level signal line from the source electrode of the fifth-first transistor to the drain electrode of the fifth-first transistor.

Referring to the first aspect and any implementation of the first aspect described above, in a seventh implementation of the first aspect, the self-raising module comprises a first capacitor; a first terminal of the first capacitor is connected to the gate signal point, and another terminal of the first capacitor is connected to the horizontal scan line.

Referring to the sixth implementation of the first aspect, in an eighth implementation of the first aspect, the inverter comprises a fifth-third transistor, a fifth-fourth transistor, a fifth-fifth transistor and a fifth-sixth transistor; the gate signal point is connected to a gate electrode of the fifth-fifth transistor and a gate electrode of the fifth-sixth transistor; a source electrode of the fifth-fifth transistor and a source electrode of the fifth-sixth transistor are connected to the third terminal of the pull-down module; a drain electrode of the fifth-fifth transistor is connected to a source electrode of the fifth-third transistor and a gate electrode of the fifth-fourth transistor; a drain electrode of the fifth-sixth transistor is connected to a source electrode of the fifth-fourth transistor, the gate electrode of the fifth-first transistor and the gate electrode of the fifth-second transistor; a gate electrode of the fifth-third transistor, a drain electrode of the fifth-third transistor and a drain electrode of the fifth-fourth transistor are connected.

In a second aspect, the present disclosure provides a driving circuit comprising a plurality of gate drivers as described in anyone of the claims 1-9; the signal down-transmitting module of the gate driver further comprises a third terminal, and the pull-up control module of the gate driver further comprises a second terminal; the third terminal of the signal down-transmitting module of a Nth one of the gate drivers is connected to the second terminal of the pull-up control module of a (N+1)-th one of the gate drivers.

The present disclosure pulls down the level of the horizontal scan line by using the pull-down module together with the pull-up module so that the pull-down effect of the gate driver and the stability of the circuit are improved.

### BRIEF DESCRIPTION OF THE DRAWINGS

In order to make the descriptions of the technique solutions of the embodiments of the present disclosure, the drawings necessary for describing the embodiments or the existed techniques are briefly introduced below.

FIG. 1 is a structural schematic diagram of a gate driver provided by he embodiment of the present disclosure.

FIG. 2 is a schematic diagram shown voltage variations of a gate driver provided by the embodiment of the present disclosure.

FIG. 3 is a structural schematic diagram of a gate driver provided by the embodiment of the present disclosure.

FIG. 4 is a structural schematic diagram of a gate driver provided by the embodiment of the present disclosure.

FIG. 5 is a schematic block diagram of a terminal facility provided by the embodiment of the present disclosure.

FIG. 6 is a schematic diagram shown voltage variations of a gate driver provided by the embodiment of the present disclosure.

FIG. 7 is a schematic diagram shown voltage variations of the gate signal point of a gate driver provided by the embodiment of the present disclosure.

### DETAILED DESCRIPTION OF PREFERRED EMBODIMENTS

The disclosure will be further described in detail with reference to accompanying drawings and preferred embodiments as follows,

It should be understood that the terms “comprise” and “comprising”, when used in this specification and the appended claims, indicate the presence of stated features, integers, steps, operations, elements, and/or components, but do not preclude the presence or addition of one or a plurality of other features, integers, steps, operations, elements, components, and/or groups thereof.

It is also to be understood that the terminology used in the description of the disclosure herein is for the purpose of describing particular embodiments only and is not intended to limit the disclosure. As used in the description of the disclosure and the appended claims, the singular forms “a”, “an” and “the” are intended to include the plural forms unless the context clearly indicates otherwise.

It is further understood that the term “and/or” as used in the specification and appended claims refers to any and all possible combinations of one or more of the associated listed items.

As used in this specification and the appended claims, the term “if” may be interpreted as “when” or “once” or “in response to a determination” or “in response to a detection” as the context. Similarly, the phrase “if determined” or “if [described condition or event] is detected” may be interpreted from the context to mean “once determined” or “in response to a determination” or “once the [described condition or event]” or “in response to detecting [described condition or event]”.

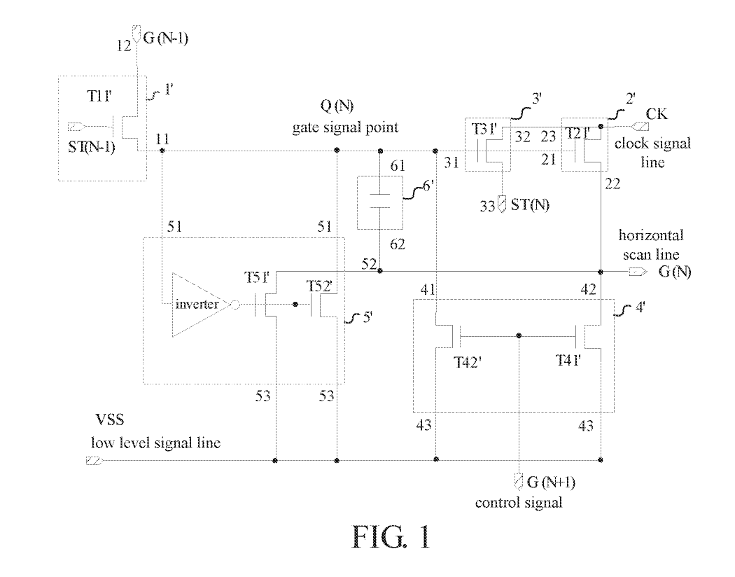

A facility with a display panel has a driving circuit for driving the display panel, and the driving circuit is usually formed by connecting a plurality of gate drivers in cascade. As shown in FIG. 1, which is a structural schematic diagram of a gate driver provided by the embodiment of the present disclosure, the gate driver in FIG. 1 comprises the pull-up control module 1′, the pull-down holding module 5′, the pull-up module 2′, the signal down-transmitting module 3′, the pull-down module 4′ and the self-raising module 6′. The pull-up control module 1′, the pull-down holding module 5′, the pull-up module 2′, the signal down-transmitting module 3′ the pull-down module 4′ and the self-raising module 6′ are connected at the gate signal point Q(N). The pull-down holding module 5′, the self-raising module 6′, the pull-up module 2′ and the pull-down module 4′ are connected to the horizontal scan line, respectively. Wherein, the pull-up control module l′ is configured for pre-charging the gate signal point Q(N), the pull-up module 2′ is configured for pulling high the potential of a point G(N) of the horizontal scan line; the signal down-transmitting module 3′ is configured for controlling on/off of the next gate driver connected to the gate driver in current; the pull-down module 4′ is configured for control the potentials of Q(N) and G(N) to be the same as the low level signal VSS; the pull-down holding module 5′ is configured for control the potentials of Q(N) and G(N) to be maintained at VSS; the self-raising module 6′ is configured for raising and maintaining the potential of Q(N).

When the pull-up control signal ST(N−1) and the signal G(N−1) of the horizontal scan line of a previous gate driver are at high level, the pull-up control module 1′ pre-charges Q(N); when the potential of Q(N) is at high level enough for driving the pull-up module 2′, the pull-up module 2′ transmits the clock signal CK to G(N) and to be the pull-up control signal ST(N) of the next gate driver; when the control signal G(N+1) is at high level, the pull-down module 4′ transmits the low level signal VSS to G(N) so that the level of G(N) is pulled down to the low level. Accordingly, the signal VSS not only is applied to stabilize the whole gate driver but also pulls G(N) at high level down to the low level, therefore the force of VSS for level pulling might be not enough, the level of the horizontal scan line cannot be pulled down by the gate driver, so that the gate of the display panel cannot be closed immediately, thereby resulting in abnormal frame display.

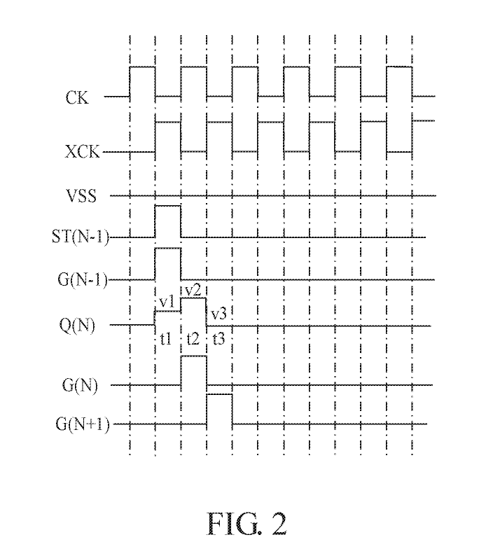

Specifically, the signal variations in the circuit are shown in FIG. 2, In the time period t1, the pull-up control signal ST(N−1) and horizontal scan signal G(N−1) transmitted from the previous gate driver are at high level, the signal ST(N−1) and G(N−1) in the time period t1 are substantially from the clock signal obtained by the previous gate driver, so that the pull-up control module 1′ pre-charges Q(N) to make Q(N) to be at high level so that the pull-up module 2′ transmits the signal of the clock signal line obtained from the third terminal of the pull-up module 2′ to the horizontal scan line through the second terminal of the pull-up module 2′. In the time period t2, because of the capacitive coupling effect, the potential of Q(N) is raised to another higher level v2 so that the pull-up module 2′ transmits the signal of the clock signal line obtained from the third terminal of the pull-up module 2′ to the horizontal scan line through the second terminal of the pull-up module 2′ to make G(N) to be at high level. Therefore, pull-up module 2′ is configured for raising the potential of the point G(N) of the horizontal scan line. In the time period t3, because the control signal G(N−1) received by the pull-down module 4′ is at high level, the pull-down module 4′ transmits the signal VSS obtained from the third terminal of the pull-down module 4′ to Q(N) and G(N) through the first terminal and second terminal of the pull-down module 4′, respectively, so that Q(N) and G(N) are at low level. Therefore, the pull-down module 4′ is configured for pull-down the potential of the point G(N) of the horizontal scan line. Accordingly, the signal VSS not only is applied to stabilize the low level of the horizontal scan lines of the whole liquid crystal panel but also pulls the horizontal scan line of the current gate driver from high level to low level, therefore the force of gate driver for level pulling might be not enough, the level of the horizontal scan lines of the liquid crystal panel cannot be pulled down immediately, thereby resulting in liquid crystal panel abnormal displaying.

To solve the problems above, the present disclosure provides a gate driver to effectively pull down the level of the gate lines of the liquid crystal panel and improve the stability of the circuit. The detailed descriptions are as follows.

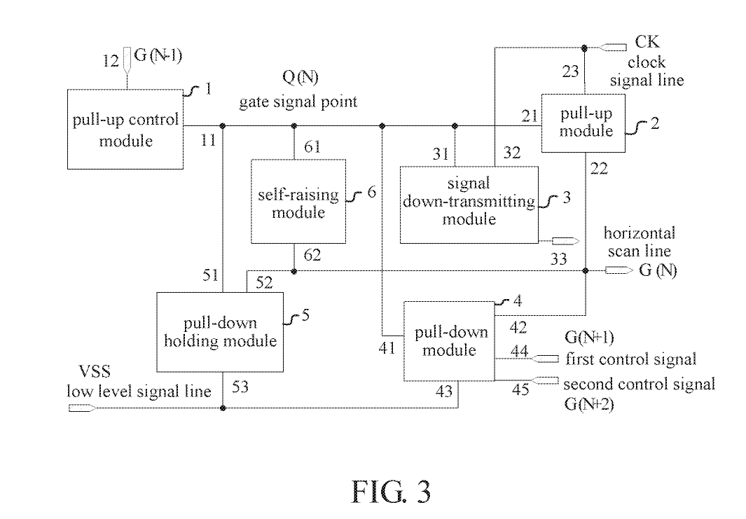

Please refer to FIG. 3, which is a structural schematic diagram of a gate driver provided by the embodiment of the present disclosure. The gate driver shown in FIG. 3 comprises the pull-up control module 1, the pull-down holding module 5, the pull-up module 2, the signal down-transmitting module 3, the pull-down module 4 and the self-raising module 6. The pull-up control module 1 comprises a first terminal; the pull-down holding module 5 comprises a first terminal, a second terminal and a third terminal; the pull-up module 2 comprises a first terminal, a second terminal and a third terminal; the signal down-transmitting module 3 comprises a first terminal and a second terminal; the pull-down module 4 comprises a first terminal, a second terminal, a third terminal, a fourth terminal and a fifth terminal; and the self-raising module 6 comprises a first terminal and a second terminal.

The first terminal 11 of the pull-up control module 1, the first terminal 21 of the pull-up module 2, the first terminal 31 of the signal down-transmitting module 3, the first terminal 41 of the pull-down module 4, the first terminal 51 of the pull-down holding module 5 and the first terminal 61 of the self-raising module 6 are connected at a gate signal point Q(N); the second terminal 52 of the pull-down holding module 5, the second terminal 42 of the pull-down module 4, the second terminal 62 of the self-raising module 6 and the second terminal 22 of the pull-up module 2 are connected to a horizontal scan line, respectively; the third terminal 53 of the pull-down holding module 5 and the third terminal 43 of the pull-down module 4 are connected to a low level signal line, respectively; the third terminal 23 of the pull-up module 2 and the second terminal 32 of the signal down-transmitting module 3 are connected to a clock signal line CK, respectively.

The pull-up control module 1 is configured for pre-charging the gate signal point Q(N), and, when the gate signal point Q(N) is at high level, the pull-up module 2 is controlled to output a signal of the clock signal line CK to the horizontal scan line; the pull-down module 4 outputs a signal of the low-level signal line VSS to the horizontal scan line when a first control signal G(N+1) received by the fourth terminal 44 of the pull-down module 4 is at high level; the pull-down module 4 outputs the signal VSS of the low level signal line to the gate signal point Q(N) to control the pull-down holding module 5 to output the signal VSS of the low level signal line to the horizontal scan line when a second control signal G(N+2) received by the fifth terminal 45 of the pull-down module 4 is at high level; the self-raising module 6 is configured for raising and maintaining a level of the gate signal point Q(N); the signal down-transmitting module 3 is configured for transmitting the signal of the clock signal line CK to other electronic component when the gate signal point Q(N) is at high level.

In some embodiments, the first control signal G(N+1) is different from the second control signal G(N+2).

It is noted that, the pull-up control module 1 is configured for pre-charging the gate signal point Q(N), the pull-up module 2 is configured for pulling up the point potential of the point G(N) on the horizontal scan line; the signal down-transmitting module 3 is configured for controlling on/off of a next gate driver connected to the current gate driver; the pull-down module 4 is configured for pulling down the potential of Q(N) and G(N) to be the same as the low level signal VSS; the pull-down holding module 4 is configured for controlling the potential of Q(N) and G(N) to be maintained at VSS; the self-raising module 6 is configured for pulling up and maintaining the potential of Q(N).

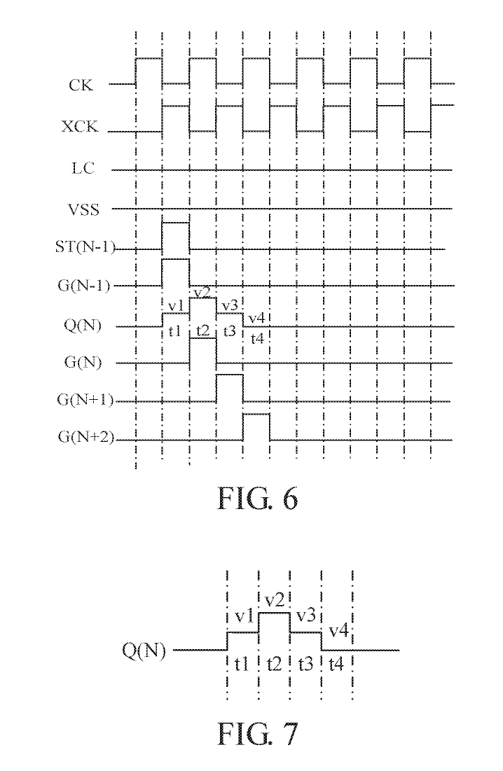

Specifically, please refer to FIG. 6 and FIG. 7 for the signal variations. In the time period t1, the pull-up control module 1 pre-charges Q(N) to a level v1 enough for driving the pull-up module 2, so that the signal of the clock signal line CK is transmitted to G(N) by the pull-up module 2 to make G(N) to be at low level (substantially, the pull-up control signal ST(N−1) and the signal G(N−1) of the horizontal scan line of the previous gate driver are obtained from the clock signal obtained by the previous gate driver), and the signal for pulling down G(N) is from the clock signal line CK. In the time period t2, because of the capacitive coupling effect, the point potential of Q(N) is raised to another high level v2 so that the pull-up module 2 continues to transmit the signal of the clock signal line CK to G(N) to make G(N) to be at high level. Therefore, pull-up module 2 is configured for raising the potential of the point G(N) of the horizontal scan line. In the time period t3, the point potential of Q(N) is pulled down to the high potential V3 because the capacitive coupling effect is ended, the pull-up module 2 continues to output the signal of the clock signal line CK to G(N) to make G(N) to be at low level, and, at the same time, the first control signal G(N+1) is at high level so that the pull-down module 4 transmits the low level signal VSS to G(N). The signals used for pulling down G(N) in the time period t3 are the signal of the clock signal line CK and the signal VSS of the low level signal line. In the time period t4, the second control signal G(N+2) is at high level, the pull-down module 4 transmits the signal VSS of the low level signal line to Q(N) to make the first terminal of the pull-down holding module 5 receives low level signal VSS, and, therefore, the pull-down holding module 5 transmits the signal VSS of the low level signal line obtained from the third terminal of the pull-down holding module 5 to G(N) through the second terminal of the pull-down holding module 5. In the time period t4, the signal used for pulling down G(N) is the signal VSS of the low level signal line.

In summary, the gate driver provided by the embodiments of the present disclosure pulls down the level of the horizontal scan line of the current gate driver by using the pull-up module 2 with the pull-down module 4 so that pull-down effect of the gate driver and stability of the circuit are effectively improved.

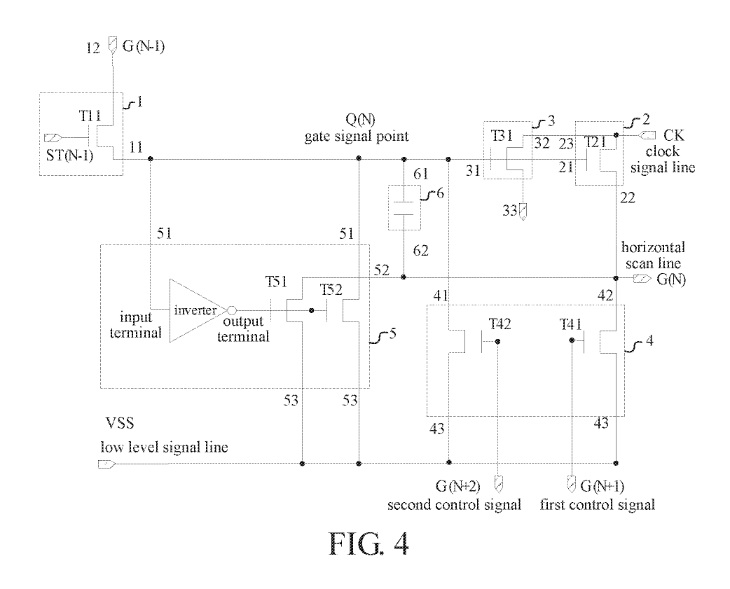

Please refer to FIG. 4, which is a detailed diagram obtained basing on FIG. 3. FIG. 4 is a structural schematic diagram of a gate driver provided by the embodiment of the present disclosure. As shown in FIG. 4:

Selectively, the pull-up control module 1 comprises the first-first transistor T11. The source electrode 11 of the first-first transistor T11 is connected to the gate signal point Q(N), and, when the gate electrode of the first-first transistor T11 is at high level, the first-first transistor T11 is controlled to transmit the signal received from the drain electrode of the first-first transistor T11 to the source electrode of the first-first transistor T11,

Selectively, the pull-up control module 2 comprises the second-first transistor T21. The gate electrode 21 of the second-first transistor T21 is connected to the gate signal point Q(N); the drain electrode 23 of the second-first transistor T21 is connected to the second terminal 32 of the signal down-transmitting module 3; and the source electrode 22 of the second-first transistor T21 is connected to the horizontal scan line; and, when the gate electrode 21 of the second-first transistor T21 is at high level, the drain electrode 23 of the second-first transistor T21 is controlled to transmit the signal of the clock signal line CK to the source electrode 22 of the second-first transistor T21.

Selectively, the signal down-transmitting module 3 comprises the third-first transistor T31. The gate electrode 31 of the third-first transistor T31 is connected to the gate signal point C(N); the drain electrode 32 of the third-first transistor T31 is connected to the third terminal 23 of the pull-up module 2; and, when the gate electrode 31 of the third-first transistor T31 is at high level, the drain electrode 32 of the third-first transistor T31 is controlled to transmit the signal of the clock signal line CK to the source electrode 33 of the third-first transistor T31.

Selectively, the pull-down module 4 comprises the fourth-first transistor T41 and the fourth-second transistor T42. The drain electrode 42 of the fourth-first transistor T41 is connected to the horizontal scan line, and the drain electrode 41 of the fourth-second transistor T42 is connected to the gate signal point Q(N); the source electrode 43 of the fourth-first transistor T41 and the source electrode 43 of the fourth-second transistor T42 are connected to the pull-down holding module 5; the gate electrode of the fourth-first transistor T41 and the gate electrode of the fourth-second transistor T42 are configured for receiving the first control signal G(N+1) and the second control signal G(N+2), respectively; when the gate electrode of the fourth-first transistor T41 is at high level, the source electrode 43 of the fourth-first transistor T41 is controlled to transmit the signal VSS of the low level signal line to the drain electrode 42 of the fourth-first transistor T41; when the gate electrode of the fourth-second transistor T42 is at high level, the source electrode 43 of the fourth-second transistor T42 is controlled to transmit the signal VSS of the low level signal line to the drain electrode 41 of the fourth-second transistor T42.

Selectively, the pull-down holding module 5 comprises the inverter, the fifth-first transistor T51 and the fifth-second transistor T52. The input terminal 51 of the inverter is connected to the gate signal point Q(N), and the output terminal of the inverter is connected to the gate electrode of the fifth-first transistor T51 and the gate electrode of the fifth-second transistor T52; the drain electrode 52 of the fifth-first transistor T51 is connected to the horizontal scan line, and the source electrode of the fifth-first transistor T51 is connected to the third terminal 43 of the pull-down module 4; the drain electrode 51 of the fifth-second transistor T52 is connected to the gate signal point Q(N), and the source electrode 53 of the fifth-second transistor T52 is connected to the third terminal 43 of the pull-down module 4; when the input terminal of the inverter is at low level, the output terminal of the inverter outputs high level to the gate electrode of the fifth-first transistor T51 to control the fifth-first transistor T51 to transmit the signal VSS of the low level signal line from the source electrode 53 of the fifth-first transistor T51 to the drain electrode 52 of the fifth-first transistor T51.

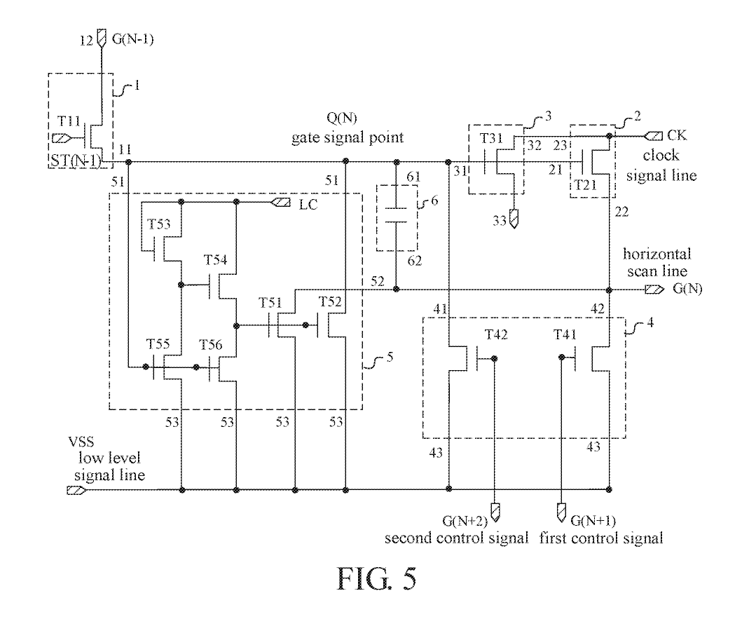

Furthermore, as shown in FIG. 5, the inverter comprises the fifth-third transistor T53, the fifth-fourth transistor T54, the fifth-fifth transistor T55 and the fifth-sixth transistor T56. The gate signal point Q(N) is connected to the gate electrode of the fifth-fifth transistor T55 and the gate electrode of the fifth-sixth transistor T56; the source electrode of the fifth-fifth transistor T55 and the source electrode of the fifth-sixth transistor T56 are connected to the third terminal 43 of the pull-down module 4; the drain electrode of the fifth-fifth transistor T55 is connected to the source electrode of the fifth-third transistor T53 and the gate electrode of the fifth-fourth transistor T54; the drain electrode of the fifth-sixth transistor T56 is connected to the source electrode of the fifth-fourth transistor T54, the gate electrode of the fifth-first transistor T51 and the gate electrode of the fifth-second transistor T52; the gate electrode of the fifth-third transistor T53, the drain electrode of the fifth-third transistor T53 and the drain electrode of the fifth-fourth transistor T54 are connected. Wherein, the input signal LC input to the drain terminal of the fifth-fourth transistor T54 of the pull-down holding module 5 is a DC high level signal, and the signal XCK is reversed to the signal of the clock signal line CK.

Selectively, the self-raising module 6 comprises the first capacitor. The first terminal of the first capacitor is connected to the gate signal point Q(N), and another terminal of the first capacitor is connected to the horizontal scan line.

Specifically, please refer to FIG. 6 and FIG. 7 for the signal variations. In the time period t1, the pull-up control signal ST(N−1) and the horizontal scan signal G(N−1) transmitted from the previous gate driver are at high level so that the gate electrode of the first-first transistor T11 of the pull-up control module 1 is at high potential and the horizontal scan signal G(N−1) is transmitted to Q(N) to pre-charge Q(N) to the level V1 enough for driving the gate electrode of the second-first transistor T21 of the pull-up module 2, so that the second-first transistor T21 of the pull-up module 2 outputs the signal of the clock signal line CK from the drain electrode to the source electrode, i.e., to the point G(N) of the horizontal scan line to make G(N) to be at low level. In the time period t2, because of the capacitive coupling effect, the point potential of Q(N) is raised to level V2 so that the second-first transistor T21 of the pull-up module 2 continues to transmit the signal of the clock signal line CK to the point G(N) of the horizontal scan line to make the horizontal scan line to be at high level. In the time period t3, the point potential of Q(N) is pulled down to the high potential V3 because the capacitive coupling effect is ended, the second-first transistor T21 of the pull-up module 2 continues to output the signal of the clock signal line CK to G(N) to make G(N) to be at low level, and, at the same time, the first control signal G(N+1) is at high level so that the fourth-first transistor T41 of the pull-down module 4 transmits the signal VSS of the low level signal line to G(N). The signals used for pulling down G(N) in the time period t3 are the signal of the clock signal line CK and the signal VSS of the low level signal line. In the time period t4, the second control signal G(N2) is at high level, the fourth-second transistor T42 of the pull-down module 4 transmits the signal VSS of the low level signal line to Q(N) to make the input terminal of the inverter to receive low level signal VSS, and, therefore, the inverter of the pull-down holding module 5 outputs high level signal to the gate electrode of the fifth-first transistor so that the signal VSS of the low level signal line obtained from the source terminal of the fifth-first transistor T51 is transmitted to G(N) through the drain terminal of the fifth-first transistor T51. In the time period t4, the signal used for pulling down G(N) is the signal VSS of the low level signal line.

In summary, the gate driver described in the embodiments of the present disclosure pulls down the level of gate signal point Q(N) by using the signal VSS of the low level signal line with the signal of the clock signal line CK so that pull-down effect of the gate driver and stability of the circuit are improved.

The present disclosure also provides a driving circuit comprising a plurality of gate drivers described in the embodiments above. The signal down-transmitting module 3 of the gate driver further comprises the third terminal 33, the pull-up control module 1 of the gate driver further comprises the second terminal 12, and the third terminal of the signal down-transmitting module 3 of the N-th gate driver is connected to the second terminal of the pull-up control module 1 of the (N+1)-th gate driver.

What is claimed is:

1. A gate driver, comprising a pull-up control module, a pull-down holding module, a pull-up module, a signal down-transmitting module, a pull-down module and a self-raising module; wherein, the pull-up control module comprises a first terminal; the pull-down holding module comprises a first terminal, a second terminal and a third terminal; the pull-up module comprises a first terminal, a second terminal and a third terminal; the signal down-transmitting module comprises a first terminal and a second terminal; the pull-down module comprises a first terminal, a second terminal, a third terminal, a fourth terminal and a fifth terminal; and the self-raising module comprises a first terminal and a second terminal;
the first terminal of the pull-up control module, the first terminal of the pull-up module, the first terminal of the signal down-transmitting module, the first terminal of the pull-down module, the first terminal of the pull-down holding module and the first terminal of the self-raising module are connected at a gate signal point; the second terminal of the pull-down holding module, the second terminal of the pull-down module, the second terminal of the self-raising module and the second terminal of the pull-up module are connected to a horizontal scan line, respectively; the third terminal of the pull-down holding module and the third terminal of the pull-down module are connected to a low level signal line, respectively; the third terminal of the pull-up module and the second terminal of the signal down-transmitting module are connected to a clock signal line, respectively;
the pull-up control module is configured for pre-charging the gate signal point, and, when the gate signal point is at high level, the pull-up module is controlled to output a signal of the clock signal line to the horizontal scan line; the pull-down module outputs a signal of the low-level signal line to the horizontal scan line when a first control signal received by the fourth terminal of the pull-down module is at high level; the pull-down module outputs the signal of the low level signal line to the gate signal point to control the pull-down holding module to output the signal of the low level signal line to the horizontal scan line when a second control signal received by the fifth terminal of the pull-down module is at high level; the self-raising module is configured for raising and maintaining a level of the gate signal point; the signal down-transmitting module is configured for transmitting the signal of the clock signal line to other electronic component when the gate signal point is at high level.

2. The gate driver according to claim 1, wherein the first control signal is different from the second control signal.

3. The gate driver according to claim 1, wherein the pull-up control module comprises a first-first transistor;
a source electrode of the first-first transistor is connected to the gate signal point; and
when a gate electrode of the first-first transistor is at high level, the first-first transistor is controlled to transmit a signal received from a drain electrode of the first-first transistor to the source electrode of the first-first transistor.

4. The gate driver according to claim 1, wherein the pull-up module comprises a second-first transistor;
a gate electrode of the second-first transistor is connected to the gate signal point; a drain electrode of the second-first transistor is connected to the second terminal of the signal down-transmitting module; and a source electrode of the second-first transistor is connected to the horizontal scan line;
when the gate electrode of the second-first transistor is at high level, the drain electrode of the second-first transistor is controlled to transmit the signal of the clock signal line to the source electrode of the second-first transistor.

5. The gate driver according to claim 1, wherein the signal down-transmitting module comprises a third-first transistor;
a gate electrode of the third-first transistor is connected to the gate signal point; and a drain electrode of the third-first transistor is connected to the third terminal of the pull-up module;
when the gate electrode of the third-first transistor is at high level, the drain electrode of the third-first transistor is controlled to transmit the signal of the clock signal line to a source electrode of the third-first transistor.

6. The gate driver according to claim 1, wherein the pull-down module comprises a fourth-first transistor and a fourth-second transistor;
a drain electrode of the fourth-first transistor is connected to the horizontal scan line, and a drain electrode of the fourth-second transistor is connected to the gate signal point; a source electrode of the fourth-first transistor and a source electrode of the fourth-second transistor are connected to the pull-down holding module; a gate electrode of the fourth-first transistor and a gate electrode of the fourth-second transistor are configured for receiving the first control signal and the second control signal, respectively;
when the gate electrode of the fourth-first transistor is at high level, the source electrode of the fourth-first transistor is controlled to transmit the signal of the low level signal line to the drain electrode of the fourth-first transistor; when the gate electrode of the fourth-second transistor is at high level, the source electrode of the fourth-second transistor is controlled to transmit the signal of the low level signal line to the drain electrode of the fourth-second transistor.

7. The gate driver according to claim 1, wherein the pull-down holding module comprises an inverter, a fifth-first transistor and a fifth-second transistor;
an input terminal of the inverter is connected to the gate signal point, and an output terminal of the inverter is connected to a gate electrode of the fifth-first transistor and a gate electrode of the fifth-second transistor; a drain electrode of the fifth-first transistor is connected to the horizontal scan line, and a source electrode of the fifth-first transistor is connected to the third terminal of the pull-down module; a drain electrode of the fifth-second transistor is connected to the gate signal point, and a source electrode of the fifth-second transistor is connected to the third terminal of the pull-down module;
when the input terminal of the inverter is at low level, the output terminal of the inverter outputs high level to the gate electrode of the fifth-first transistor to control the fifth-first transistor to transmit the signal of the low level signal line from the source electrode of the fifth-first transistor to the drain electrode of the fifth-first transistor.

8. The gate driver according to claim 1, wherein the self-raising module comprises a first capacitor;
a first terminal of the first capacitor is connected to the gate signal point, and another terminal of the first capacitor is connected to the horizontal scan line.

9. The gate driver according to claim 7, wherein the inverter comprises a fifth-third transistor, a fifth-fourth transistor, a fifth-fifth transistor and a fifth-sixth transistor;
the gate signal point is connected to a gate electrode of the fifth-fifth transistor and a gate electrode of the fifth-sixth transistor; a source electrode of the fifth-fifth transistor and a source electrode of the fifth-sixth transistor are connected to the third terminal of the pull-down module; a drain electrode of the fifth-fifth transistor is connected to a source electrode of the fifth-third transistor and a gate electrode of the fifth-fourth transistor; a drain electrode of the fifth-sixth transistor is connected to a source electrode of the fifth-fourth transistor, the gate electrode of the fifth-first transistor and the gate electrode of the fifth-second transistor; a gate electrode of the fifth-third transistor, a drain electrode of the fifth-third transistor and a drain electrode of the fifth-fourth transistor are connected.

10. A driving circuit, comprising a plurality of gate drivers, wherein each of the gate drivers comprises: a pull-up control module, a pull-down holding module, a pull-up module, a signal down-transmitting module, a pull-down module and a self-raising module; wherein, the pull-up control module comprises a first terminal; the pull-down holding module comprises a first terminal, a second terminal and a third terminal; the pull-up module comprises a first terminal, a second terminal and a third terminal; the signal down-transmitting module comprises a first terminal and a second terminal; the pull-down module comprises a first terminal, a second terminal, a third terminal, a fourth terminal and a fifth terminal; and the self-raising module comprises a first terminal and a second terminal;
the first terminal of the pull-up control module, the first terminal of the pull-up module, the first terminal of the signal down-transmitting module, the first terminal of the pull-down module, the first terminal of the pull-down holding module and the first terminal of the self-raising module are connected at a gate signal point; the second terminal of the pull-down holding module, the second terminal of the pull-down module, the second terminal of the self-raising module and the second terminal of the pull-up module are connected to a horizontal scan line, respectively; the third terminal of the pull-down holding module and the third terminal of the pull-down module are connected to a low level signal line, respectively; the third terminal of the pull-up module and the second terminal of the signal down-transmitting module are connected to a clock signal line, respectively;
the pull-up control module is configured for pre-charging the gate signal point, and, when the gate signal point is at high level, the pull-up module is controlled to output a signal of the clock signal line to the horizontal scan line; the pull-down module outputs a signal of the low-level signal line to the horizontal scan line when a first control signal received by the fourth terminal of the pull-down module is at high level; the pull-down module outputs the signal of the low level signal line to the gate signal point to control the pull-down holding module to output the signal of the low level signal line to the horizontal scan line when a second control signal received by the fifth terminal of the pull-down module is at high level; the self-raising module is configured for raising and maintaining a level of the gate signal point; the signal down-transmitting module is configured for transmitting the signal of the clock signal line to other electronic component when the gate signal point is at high level;
the signal down-transmitting module further comprises a third terminal, and the pull-up control module further comprises a second terminal;
the third terminal of the signal down-transmitting module of a N-th one of the gate drivers is connected to the second terminal of the pull-up control module of a (N+1)-th one of the gate drivers.

11. The driving circuit according to claim 10, wherein the first control signal is different from the second control signal.

12. The driving circuit according to claim 10, wherein the pull-up control module comprises a first-first transistor;
a source electrode of the first-first transistor is connected to the gate signal point; and
when a gate electrode of the first-first transistor is at high level, the first-first transistor is controlled to transmit a signal received from a drain electrode of the first-first transistor to the source electrode of the first-first transistor.

13. The driving circuit according to claim 10, wherein the pull-up module comprises a second-first transistor;
a gate electrode of the second-first transistor is connected to the gate signal point; a drain electrode of the second-first transistor is connected to the second terminal of the signal down-transmitting module; and a source electrode of the second-first transistor is connected to the horizontal scan line;
when the gate electrode of the second-first transistor is at high level, the drain electrode of the second-first transistor is controlled to transmit the signal of the clock signal line to the source electrode of the second-first transistor.

14. The driving circuit according to claim 10, wherein the signal down-transmitting module comprises a third-first transistor;
a gate electrode of the third-first transistor is connected to the gate signal point; and a drain electrode of the third-first transistor is connected to the third terminal of the pull-up module;
when the gate electrode of the third-first transistor is at high level, the drain electrode of the third-first transistor is controlled to transmit the signal of the clock signal line to a source electrode of the third-first transistor.

15. The driving circuit according to claim 10, wherein the pull-down module comprises a fourth-first transistor and a fourth-second transistor;
a drain electrode of the fourth-first transistor is connected to the horizontal scan line, and a drain electrode of the fourth-second transistor is connected to the gate signal point; a source electrode of the fourth-first transistor and a source electrode of the fourth-second transistor are connected to the pull-down holding module; a gate electrode of the fourth-first transistor and a gate electrode of the fourth-second transistor are configured for receiving the first control signal and the second control signal, respectively;
when the gate electrode of the fourth-first transistor is at high level, the source electrode of the fourth-first transistor is controlled to transmit the signal of the low level signal line to the drain electrode of the fourth-first transistor; when the gate electrode of the fourth-second transistor is at high level, the source electrode of the fourth-second transistor is controlled to transmit the signal of the low level signal line to the drain electrode of the fourth-second transistor.

16. The driving circuit according to claim 10, wherein the pull-down holding module comprises an inverter, a fifth-first transistor and a fifth-second transistor;
an input terminal of the inverter is connected to the gate signal point, and an output terminal of the inverter is connected to a gate electrode of the fifth-first transistor and a gate electrode of the fifth-second transistor; a drain electrode of the fifth-first transistor is connected to the horizontal scan line, and a source electrode of the fifth-first transistor is connected to the third terminal of the pull-down module; a drain electrode of the fifth-second transistor is connected to the gate signal point, and a source electrode of the fifth-second transistor is connected to the third terminal of the pull-down module;
when the input terminal of the inverter is at low level, the output terminal of the inverter outputs high level to the gate electrode of the fifth-first transistor to control the fifth-first transistor to transmit the signal of the low level signal line from the source electrode of the fifth-first transistor to the drain electrode of the fifth-first transistor.

17. The driving circuit according to claim 10, wherein the self-raising module comprises a first capacitor;
a first terminal of the first capacitor is connected to the gate signal point, and another terminal of the first capacitor is connected to the horizontal scan line.

18. The driving circuit according to claim 16, wherein the inverter comprises a fifth-third transistor, a fifth-fourth transistor, a fifth-fifth transistor and a fifth-sixth transistor;
the gate signal point is connected to a gate electrode of the fifth-fifth transistor and a gate electrode of the fifth-sixth transistor; a source electrode of the fifth-fifth transistor and a source electrode of the fifth-sixth transistor are connected to the third terminal of the pull-down module; a drain electrode of the fifth-fifth transistor is connected to a source electrode of the fifth-third transistor and a gate electrode of the fifth-fourth transistor; a drain electrode of the fifth-sixth transistor is connected to a source electrode of the fifth-fourth transistor, the gate electrode of the fifth-first transistor and the gate electrode of the fifth-second transistor; a gate electrode of the fifth-third transistor, a drain electrode of the fifth-third transistor and a drain electrode of the fifth-fourth transistor are connected.
